(19) United States
(12) Patent Application Publication
(10) Pub. No.: US 2026/0342661 A1
(43) Pub. Date: Oct. 29, 2026

(54) SYSTEMS AND METHODS FOR AUTOMATING NETWORK SLICE ASSIGNMENT

(71) Applicant: Verizon Patent and Licensing Inc., Basking Ridge, NJ (US)

(72) Inventors: Praveen VENKATARAMU, Raritan, NJ (US); Umesh Kumar GUPTA, Morris Plains, NJ (US)

(73) Assignee: Verizon Patent and Licensing Inc., Basking Ridge, NJ (US)

(21) Appl. No.: 19/192,033

(22) Filed: Apr. 28, 2025

(51) Int. Cl. H04L 41/0895; H04L 41/0894

(52) U.S. Cl. CPC H04L 41/0895; H04L 41/0894

(57) ABSTRACT

A device may provide a plurality of network slice categories for an application, and may receive a network slice category selected from the plurality of network slice categories. The device may map the network slice category to a traffic descriptor, and may associate the traffic descriptor with a data network name (DNN) for a network slice. The device may provide the DNN to a user device associated with the application, and may receive, from the user device, a request for the network slice based on the DNN. The device may allocate the network slice to the user device based on the request and for provision of the application.

### BACKGROUND

Network slicing is a technology that holds great promise for customizing network services to match specific user requirements. Network slicing enables networks to provide different slices or segments with tailored connectivity that can support diverse applications, services, or user groups with varying performance needs.

### BRIEF DESCRIPTION OF THE DRAWINGS

FIGS. 1A-1E are diagrams of an example associated with automating network slice assignment.

FIG. 2 is a diagram of an example environment in which systems and/or methods described herein may be implemented.

FIG. 3 is a diagram of example components of one or more devices of FIG. 2.

FIG. 4 is a flowchart of an example process for automating network slice assignment.

### DETAILED DESCRIPTION OF EXAMPLE EMBODIMENTS

The following detailed description of example implementations refers to the accompanying drawings. The same reference numbers in different drawings may identify the same or similar elements.

Despite the benefits of network slicing there is fragmentation and complexity in current network slicing frameworks, especially across different operating systems, such as the Android operating system and the Apple iOS operating system. Application developers are required to write additional code specific to network slicing, which can be burdensome. For the Android operating system, applications must include code to utilize a network slice, while for the Apple iOS operating system, applications must also be coded unless the applications employ a communication-specific Apple framework that automatically assigns the applications to a communication network slice. However, this automatic assignment of the network slice is not scalable for future slice categories. Enterprise-managed applications face additional problems since mobile device management (MDM) solutions must also code platform-specific application programming interfaces (APIs) to assign one or more applications to a network slice. This demands that MDM solutions be aware of the network slice implementation of each network, complicating the management and operation of network slices.

Currently, network slicing requires significant coding efforts from both application developers and MDM solution providers, which hinders the seamless integration of applications into network slices and limits the flexibility and scalability of network slicing as a service offering. Thus, current techniques for allocating network slices consume computing resources (e.g., processing resources, memory resources, communication resources, and/or the like), networking resources, and/or other resources associated with failing to provide network slices for applications, requiring application developers to create additional code specific to network slicing, coding platform-specific APIs to assign one or more applications to a network slice, and/or the like.

Some implementations described herein provide a network system that automates network slice assignment. For example, the network system may provide a plurality of network slice categories for an application, and may receive a network slice category selected from the plurality of network slice categories. The network system may map the network slice category to a traffic descriptor, and may associate the traffic descriptor with a data network name (DNN) for a network slice. The network system may provide the DNN to a user device associated with the application, and may receive, from the user device, a request for the network slice based on the DNN. The network system may allocate the network slice to the user device based on the request and for provision of the application.

In some implementations, the network system may achieve uniformity in the slice framework implementation between different operating systems, such as iOS and Android. This uniformity may eliminate a need for application developers to write additional code specific to network slicing for each operating system. By standardizing slice frameworks, the network system may simplify the integration of network slicing across various platforms, thereby promoting wider adoption and seamless operation of applications regardless of the underlying operating system.

In this way, the network system automates network slice assignment. For example, the network system may automate network slice assignments through a one-time selection process during application submission to an application store. The network system may minimize the need for manual coding and may reduce the complexity of network slice integration. The network system may provide a selection of network slice categories to an application developer, may receive a chosen network slice category, and may map this category to a traffic descriptor. The network system may associate the traffic descriptor with a DNN that corresponds to a network slice, and may provide the DNN to a user device of an application user. When the application is launched on the user device, a request for the network slice is received by the network system based on the DNN, and the network system may allocate the network slice to the user device for the application's use. Thus, the network system may conserve computing resources, networking resources, and/or other resources that would have otherwise been consumed by failing to provide network slices for applications, requiring application developers to create additional code specific to network slicing, coding platform-specific APIs to assign one or more applications to a network slice, and/or the like.

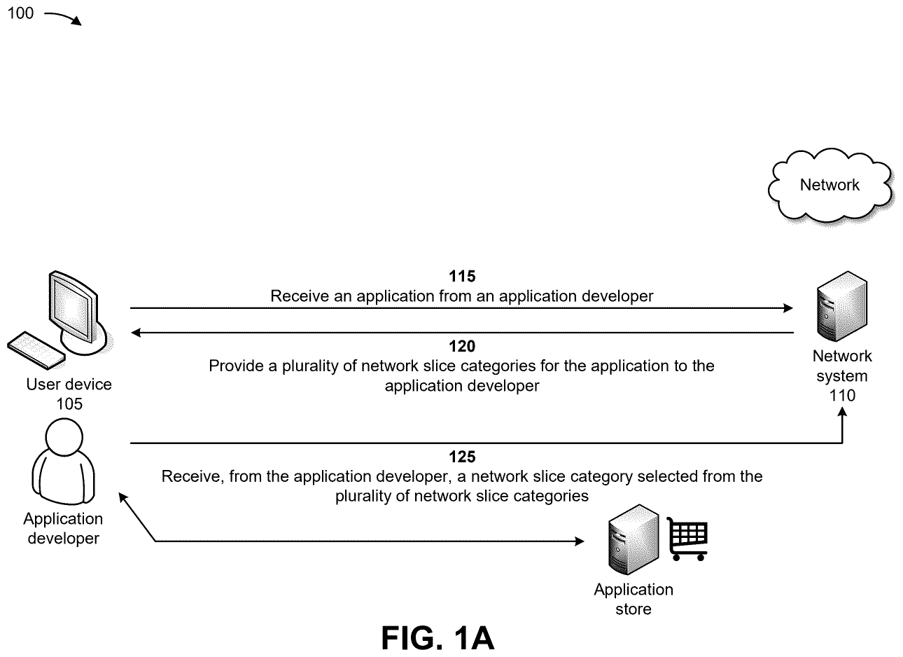

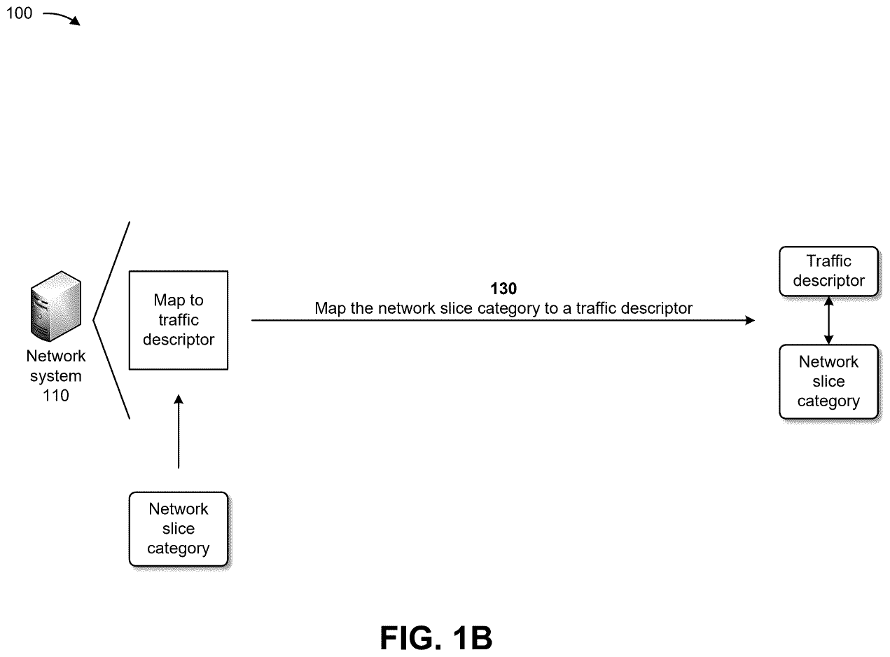

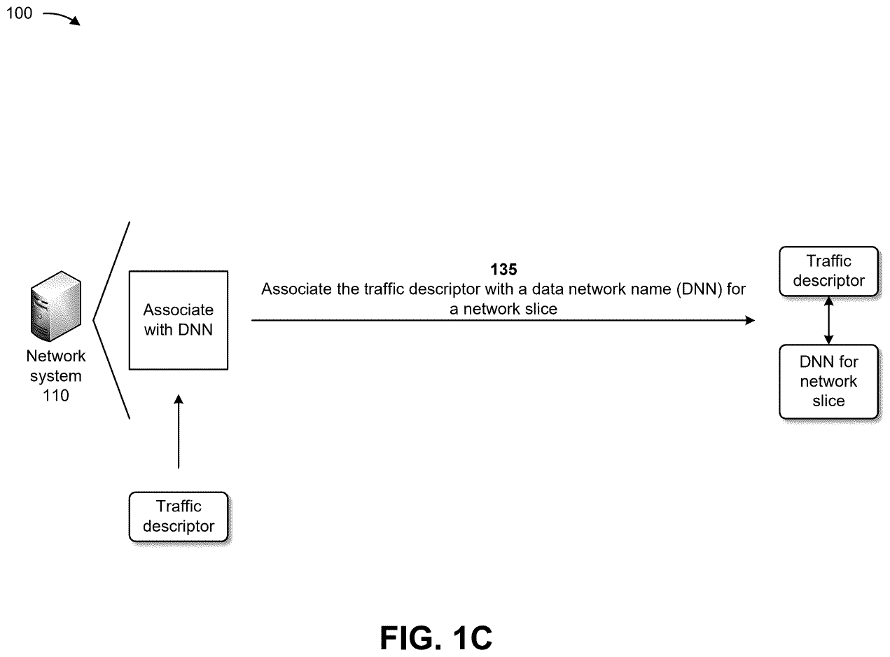

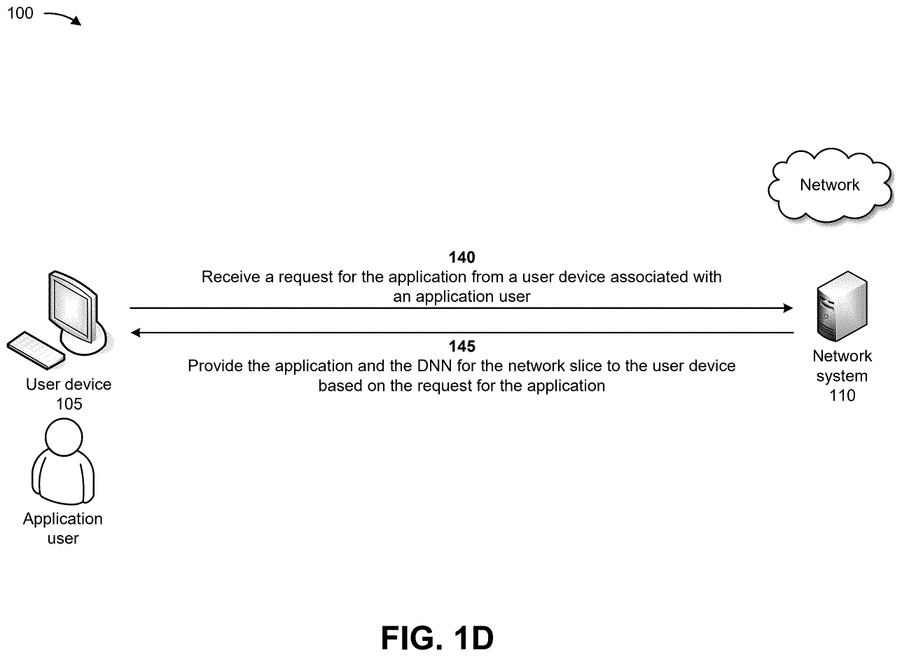

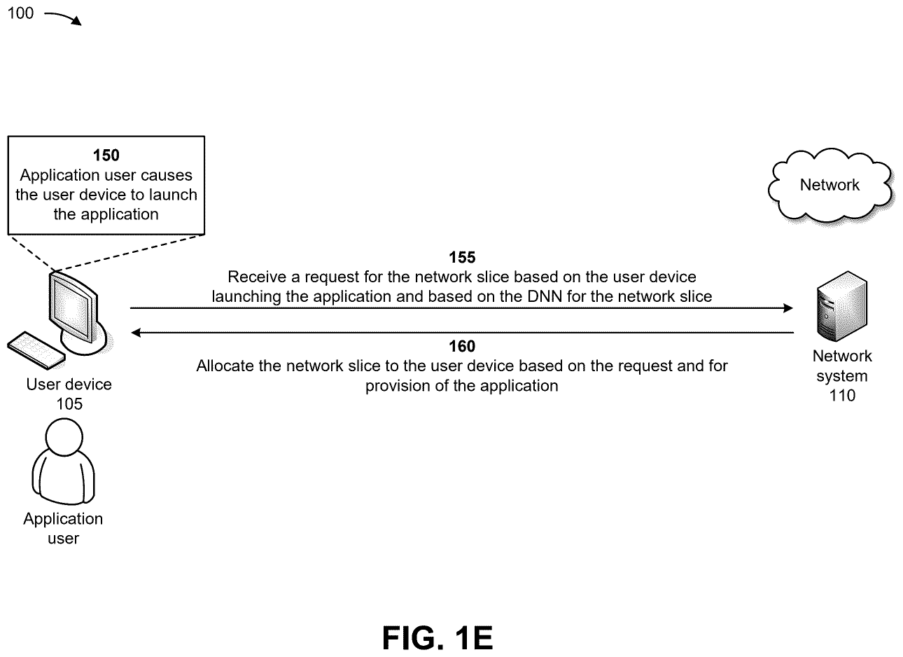

FIGS. 1A-1E are diagrams of an example 100 associated with automating network slice assignment. As shown in FIGS. 1A-1E, the example 100 includes a user device 105 associated with an application developer or an application user, a network system 110, and a network. The application developer may utilize the user device 105 to interact with the network system 110 and/or the network. The network system 110 may include a system that automates network slice assignment. The network may include a network (e.g., a fifth generation (5G) core network) capable of providing network slices for applications generated by the application developer. Further details of the user device 105, the network system 110, and the network are provided elsewhere herein. Although implementations described herein depict a single user device 105, in some implementations, the network system 110 may be associated with multiple user devices 105.

As shown by FIG. 1A, and by reference number 115, the network system 110 may receive an application from an application developer. For example, the application developer may utilize a user device 105 to generate the application and to provide the application to an application store. The user device 105 may include a computing or communication device capable of interacting with the application store. The application store may include a digital marketplace where users can browse, download, and install software applications and games for user devices 105, such as smartphones, tablets, and computers. The application store may offer a wide range of applications, including productivity tools, entertainment applications, educational software, and/or the like. The application store may provide user reviews, ratings, and detailed descriptions to help users make informed decisions. The application store may be provided by one or more server devices, a cloud-based system, and/or the like. In such implementations, the network system 110 may receive the application from the application store. Alternatively, or additionally, the application developer may utilize the user device 105 to submit the application directly to the network system 110 (e.g., via a portal or user interface provided by the network system 110). The user device 105 may include a computing or communication device capable of interacting with the network system 110. In such implementations, the network system 110 may receive the application directly from the user device 105 associated with the application developer.

In some implementations, the application may include an application managed by an enterprise or an application not managed by an enterprise. An enterprise-managed application and an application not managed by an enterprise may differ in terms of management, distribution, and usage contexts. An enterprise-managed application may be centrally managed by an organization, and the organization may manage deployment, updates, security policies, and access controls of the enterprise-managed application. An enterprise-managed application may be integrated with an MDM system that enables administrators to enforce security policies, manage application configurations, and monitor usage. An enterprise-managed application may be subject to strict security protocols, including encryption, authentication, compliance with industry standards, and data protection. An enterprise-managed application may be customized to meet specific needs of the organization, including integration with other enterprise systems, and distribution of an enterprise-managed application may be restricted to employees or authorized users within the organization.

An application not managed by an enterprise may be managed by individual users, who are responsible for installation, updates, and configurations, and may be distributed through public application stores accessible to anyone. Security measures for an application not managed by an enterprise are less stringent compared to enterprise-managed applications. A user of an application not managed by an enterprise has limited control over data protection and security settings. An application not managed by an enterprise may be designed for a broad audience and may not offer a level of customization or integration required by enterprises. Support for an application not managed by an enterprise may be provided by the application developers, and users may be responsible for manually updating the application through the application store.

As further shown in FIG. 1A, and by reference number 120, the application store or the network system 110 may provide a plurality of network slice categories for the application to the application developer (e.g., via a portal provided by the application store). For example, the network system 110 may determine various network slice categories, such as a communication network slice category, a gaming network slice category, a streaming network slice category, an enterprise network slice category, a prioritized bandwidth network slice category, a prioritized latency network slice category, a custom network slice category, an unassigned network slice category, and/or the like. The network system 110 may provide the plurality of network slice categories to the user device 105 associated with the application developer, and the user device 105 may display the plurality of network slice categories to the application developer. Alternatively, the network system 110 may provide the plurality of network slice categories to the application store, and the application store may provide the plurality of network slice categories to the user device 105 associated with the application developer.

In some implementations, the network system 110 may provide detailed descriptions and examples of each network slice category to assist the application developer in making an informed selection. For example, the network system 110 may include descriptions, documentation, and/or case studies that highlight benefits and use cases of different network slice categories. Additionally, or alternatively, the network system 110 may receive feedback from the application developer regarding the suitability of the plurality of network slice categories for future improvements. The network system 110 may utilize the feedback to refine and enhance the network slice categories offered by the network system 110. Additionally, or alternatively, the network system 110 may provide, to the application developer, a preview of the application's performance metrics under each of the plurality of network slice categories. For example, a preview may include estimated latency, bandwidth, and reliability metrics associated with each of the plurality of network slice categories.

As further shown in FIG. 1A, and by reference number 125, the network system 110 may receive, from the application developer, a network slice category selected from the plurality of network slice categories. For example, the application developer may utilize the user device 105 to select, from the plurality of network slice categories, a network slice category for the application. The user device 105 may provide an indication of the selected network slice category to the network system 110, and the network system 110 may receive the indication from the user device 105. Alternatively, the user device 105 may provide the indication of the selected network slice category to the application store, and the application store may provide the indication to the network system 110. In some implementations, if the application developer fails to select a network slice category, the network system 110 may automatically select a network slice category based on the application's function or the network slice category may be unassigned. The network system 110 may not assign a network slice to an application mapped to an unassigned network slice category.

In some implementations, once the application developer selects a network slice category, the network system 110 may validate the selection based on rules and criteria. For example, the network system 110 may validate the selection by checking a compatibility of the selected network slice category with the application's requirements and network capabilities. Additionally, or alternatively, the network system 110 may associate the selected network slice category with application metadata, and may store an identification of the selected network slice category and the associated application metadata in a data structure (e.g., a database, a table, a list, and/or the like) for future reference. The network system 110 may utilize the stored information for monitoring and managing the application over time. Additionally, or alternatively, the network system 110 may enable the application developer to update the selected network slice category at a later time if the application's requirements change. This flexibility may enable the application developer to adapt to evolving needs and conditions.

As shown by FIG. 1B, and by reference number 130, the network system 110 may map the network slice category to a traffic descriptor. For example, the network system 110 may determine a corresponding traffic descriptor that aligns with the selected network slice category. In some implementations, the network system 110 may utilize predefined mappings between network slice categories and traffic descriptors to map the network slice category to one of the traffic descriptors. This mapping may ensure that traffic associated with the application is appropriately categorized and managed within the network slice framework. The network system 110 may store the mapping of the network slice category to the traffic descriptor in a data structure for subsequent operations, such as network slice allocation and application traffic management.

In some implementations, the network system 110 may utilize a lookup table or a database to map the network slice category to the traffic descriptor. The lookup table or database may store predefined associations between network slice categories and traffic descriptors, allowing for quick and efficient mapping. Additionally, or alternatively, the network system 110 may dynamically generate traffic descriptors based on the network slice category, and may map one of the dynamically generated traffic descriptors to the network slice category. The dynamically generated traffic descriptors may provide flexibility in adapting to varying network conditions and application requirements.

Additionally, or alternatively, the network system 110 may utilize a rule-based system that considers application type and usage patterns to map the network slice category to the traffic descriptor. The rule-based system may optimize traffic management by considering the unique demands of different applications. Additionally, or alternatively, the network system 110 may consult a policy server when mapping the network slice category to the traffic descriptor to ensure that the mapping is compliant with network policies.

As shown in FIG. 1C, and by reference number 135, the network system 110 may associate the traffic descriptor with a DNN for a network slice. For example, a DNN may provide a unique identifier for a network slice in mobile networks (e.g., a 5G core network). The DNN may specify a particular data network to which a user device 105 is to connect to access the network slice. The DNN may direct traffic to an appropriate network slice, which is a virtualized and isolated segment of the network tailored to meet specific service requirements, such as low latency for gaming or high bandwidth for streaming. By associating a DNN with a network slice, the network may ensure that application traffic is handled according to predefined performance and quality of service (QoS) parameters of the network slice. In some implementations, the DNN may include a DNN associated with an enhance mobile broadband (eMBB) premium network slice, a gaming network slice, a streaming network slice, a prioritized bandwidth network slice, a prioritized latency network slice, and/or the like.

In some implementations, the network system 110 may associate or map the traffic descriptor with the DNN for the network slice to ensure that traffic from the application is correctly directed to the appropriate network slice based on the DNN. Additionally, or alternatively, the network system 110 may utilize predefined mappings between traffic descriptors and DNNs to map the traffic descriptor with the DNN for the network slice. These mappings may be stored in a data structure for efficient retrieval during network slice allocation. Additionally, or alternatively, the network system 110 may utilize a lookup table or a database to map the traffic descriptor to the DNN for the network slice. For example, the lookup table or the database may include entries that directly correlate traffic descriptors with corresponding DNNs, allowing quick and accurate association. Additionally, or alternatively, the network system 110 may utilize a rules engine to associate the traffic descriptor with the DNN. The rules engine may apply business logic to determine the appropriate DNN for association with the traffic descriptor, and may utilize factors, such as application type, user preferences, and service level agreements, to determine the DNN for association with the traffic descriptor.

Additionally, or alternatively, the network system 110 may receive updates from the application developer regarding the network slice category and may adjust the traffic descriptor to DNN association accordingly. The updates may include changes in application behavior or new requirements that necessitate adjustments in network slice allocation. Additionally, or alternatively, the network system 110 may provide a user interface for a network administrator to manually configure the association of the traffic descriptor with the DNN for specific applications or network slices. The user interface may include tools and options for the network administrator to fine-tune network slice allocations based on expertise and network management strategies. Additionally, or alternatively, the network system 110 may utilize a hierarchical mapping structure to associate the traffic descriptor with a primary DNN and a secondary DNN, enabling redundancy and failover capabilities. This may ensure that the application maintains connectivity and performance even when the primary DNN fails.

In some implementations, for each network slice category, an application user or an enterprise network administrator may select a differentiated network slice as agreed via other communication channels (e.g., by paying a premium price). For example, if the network slice category is a communication network slice, the application user or the enterprise network administrator may select a premium communication network slice for the application or for an enterprise-managed application. In some implementations, the network system 110 may provide the DNN for the differentiated network slice to an MDM system associated with the enterprise network administrator. The MDM system may push the DNN for the differentiated network slice to user devices 105 associated with the enterprise.

Additionally, the network system 110 may enable networks to offer differentiated network slicing via a portal for a given category of applications. The portal may enable network operators to provide specialized network slices tailored to specific performance requirements, such as enhanced bandwidth or reduced latency, which can be selected by application developers or enterprise users. This flexibility may ensure that applications receive the optimal network resources required for their operation, enhancing user experience and application performance.

As shown by FIG. 1D, and by reference number 140, the network system 110 may receive a request for the application from a user device 105 associated with an application user. For example, the application user may utilize the user device 105 to generate the request for the application (e.g., to download the application) and to provide the request to the application store or another source. The user device 105 may include a computing or communication device capable of interacting with the application store or the other source to initiate the request for the application. In some implementations, the network system 110 may receive the request for the application from the application store or the other source. Alternatively, or additionally, the network system 110 may receive the request for the application directly from the from the user device 105 associated with the application user, and may process the request to determine the appropriate application and associated information.

As further shown in FIG. 1D, and by reference number 145, the network system 110 may provide the application and the DNN for the network slice to the user device 105 based on the request. For example, in response to receiving the request for the application, the network system 110 may retrieve the application from a data structure (e.g., a database, a cloud storage service, and/or the like) and may provide the application to the user device 105. In some implementations, the application store or the other source may provide the application to the user device 105 associated with the application user, rather than the network system 110.

Additionally, the network system 110 may determine the DNN for the network slice that corresponds to the application based on the previously mapped traffic descriptor and network slice category and the association between the traffic descriptor and the DNN for the network slice. For example, the network system 110 may determine the network slice category for the application identified in the request, and may determine the traffic descriptor based on the mapping of the network slice category to the traffic descriptor. The network system 110 may determine the DNN for the network slice based on the association between the traffic descriptor and the DNN for the network slice. The network system 110 may then provide the DNN for the network slice (e.g., with or without the application) to the user device 105 associated with the application user to ensure that the application can utilize the appropriate network slice for operation once the application is launched on the user device 105.

In some implementations, the network system 110 may provide the DNN to the user device 105 via a user equipment route selection policy (URSP). A URSP is a mechanism used in mobile networks, particularly in 5G networks, to manage and direct traffic from user devices 105 to specific network slices based on predefined policies. The URSP may define rules that determine how different types of application traffic should be routed through the network. These rules can be based on various criteria, such as application type, QoS requirements, user preferences, and/or the like. The URSP may ensure that traffic is efficiently managed and that applications receive the appropriate network resources to meet their performance needs.

As shown by FIG. 1E, and by reference number 150, the application user may cause the user device 105 to launch the application. For example, the application user may interact with the user device 105 to initiate execution or launch of the application on the user device 105. The user device 105 may provide a user interface that enables the application user to execute and display the application. In some implementations, the application user may, for example, select an icon for the application or select the application from a menu, and the selection may cause the user device 105 to launch the application. In another example, the application user may select a shortcut or use a voice command to launch the application on the user device 105. Additionally, or alternatively, the application user may select a button or swipe a display screen to cause the user device 105 to launch the application.

As further shown in FIG. 1E, and by reference number 155, the network system 110 may receive a request for the network slice based on the user device 105 launching the application and based on the DNN for the network slice. For example, upon launching the application, the user device 105 may generate a request for a network of the network slice corresponding to the DNN provided by the network system 110. In some implementations, when the application generates a data connection request, an operating system of the user device 105 may provide the application related traffic descriptor to a modem of the user device 105. The modem of the user device 105 may analyze the URSP (e.g., the DNN) received from the network system 110, and may identify the traffic descriptor matching the DNN. When identified, the user device 105 may generate the request for the network slice (e.g., which includes the DNN for the network slice), and may provide the request for the network slice to the network system 110. The network system 110 may receive the request for the network slice and the DNN for the network slice from the user device 105.

As further shown in FIG. 1E, and by reference number 160, the network system 110 may allocate the network slice to the user device 105 based on the request and for provision of the application. For example, the network system 110, upon receiving the request and the DNN for the network slice, may allocate the network slice to the user device 105, ensuring that the application traffic is managed according to the predefined performance and QoS parameters associated with the network slice. In some implementations, the network slice may be utilized to perform functions associated with the application. For example, if the application is a virtual reality game, the network slice may allocate resources to support features of the virtual reality game, such as three-dimensional rendering, connection with other players of the virtual reality game, and/or the like. Thus, the user device 105 may receive access to the network slice that best fits the application's data needs as determined by the network system 110. For example, the network slice may be configured to prioritize bandwidth or latency to optimize the application's performance. Additionally, the network system 110 may include a monitoring and logging service to track the performance and utilization of the allocated network slices, and to provide real-time insights and alerts to network administrators.

In this way, the network system 110 automates network slice assignment. For example, the network system 110 may automate network slice assignments through a one-time selection process during application submission to an application store. The network system 110 may minimize the need for manual coding and may reduce the complexity of network slice integration. The network system 110 may provide a selection of network slice categories to an application developer, may receive a chosen network slice category, and may map this category to a traffic descriptor. The network system 110 may associate the traffic descriptor with a DNN that corresponds to a network slice, and may provide the DNN to a user device 105 of an application user. When the application is launched on the user device 105, a request for the network slice is received by the network system 110 based on the DNN, and the network system 110 may allocate the network slice to the user device 105 for the application's use. Thus, the network system 110 may conserve computing resources, networking resources, and/or other resources that would have otherwise been consumed by failing to provide network slices for applications, requiring application developers to create additional code specific to network slicing, coding platform-specific APIs to assign one or more applications to a network slice, and/or the like.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in

FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

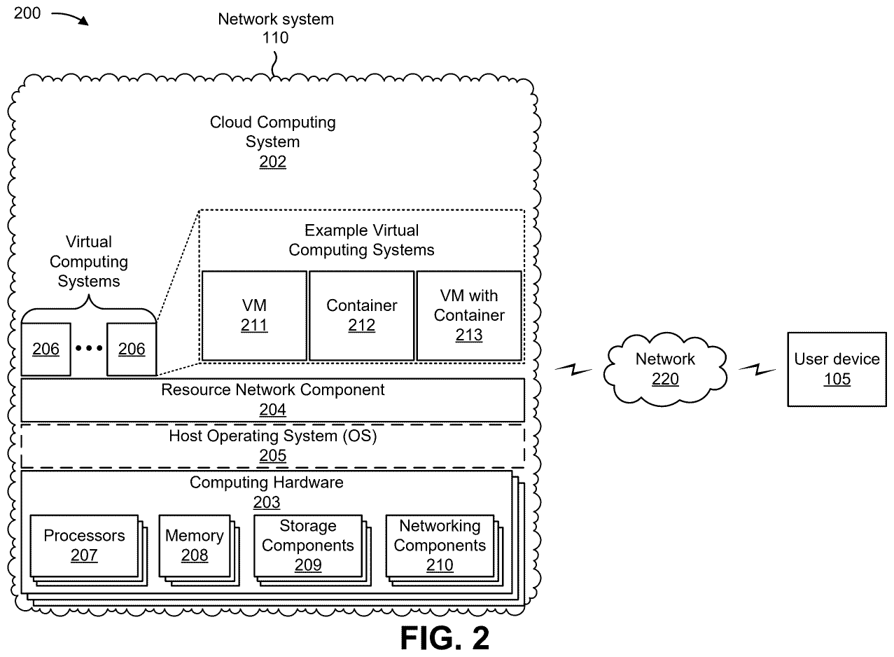

FIG. 2 is a diagram of an example environment 200 in which systems and/or methods described herein may be implemented. As shown in FIG. 2, the environment 200 may include the network system 110, which may include one or more elements of and/or may execute within a cloud computing system 202. The cloud computing system 202 may include one or more elements 203-213, as described in more detail below. As further shown in FIG. 2, the environment 200 may include the user device 105 and/or a network 220. Devices and/or elements of the environment 200 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

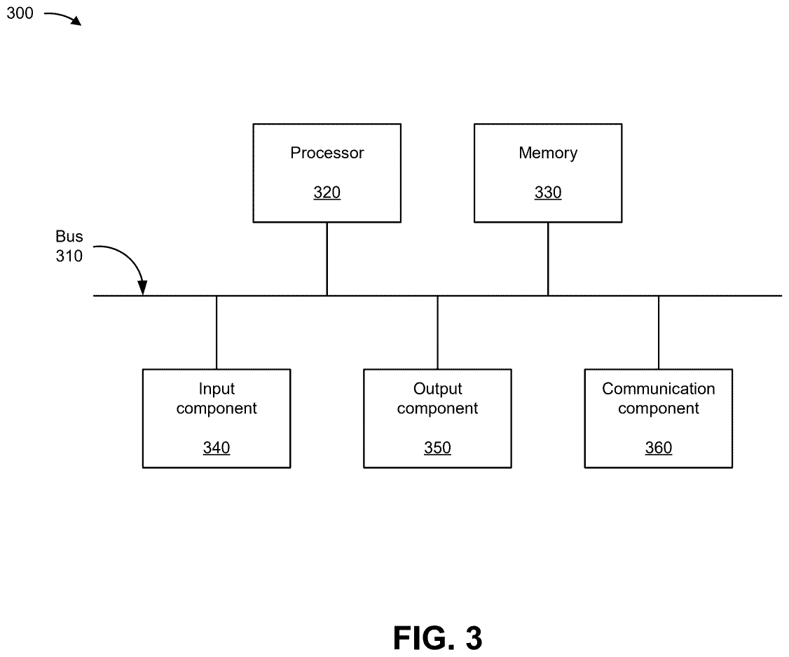

Although the network system 110 may include one or more elements 203-213 of the cloud computing system 202, may execute within the cloud computing system 202, and/or may be hosted within the cloud computing system 202, in some implementations, the network system 110 may not be cloud-based (e.g., may be implemented outside of a cloud computing system) or may be partially cloud-based. For example, the network system 110 may include one or more devices that are not part of the cloud computing system 202, such as a device 300 of FIG. 3, which may include a standalone server or another type of computing device. The network system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200. In some implementations, the network 220 includes a network capable of providing network slices, such as a 5G core network.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105 and/or the network system 110. In some implementations, the user device 105 and/or the network system 110 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

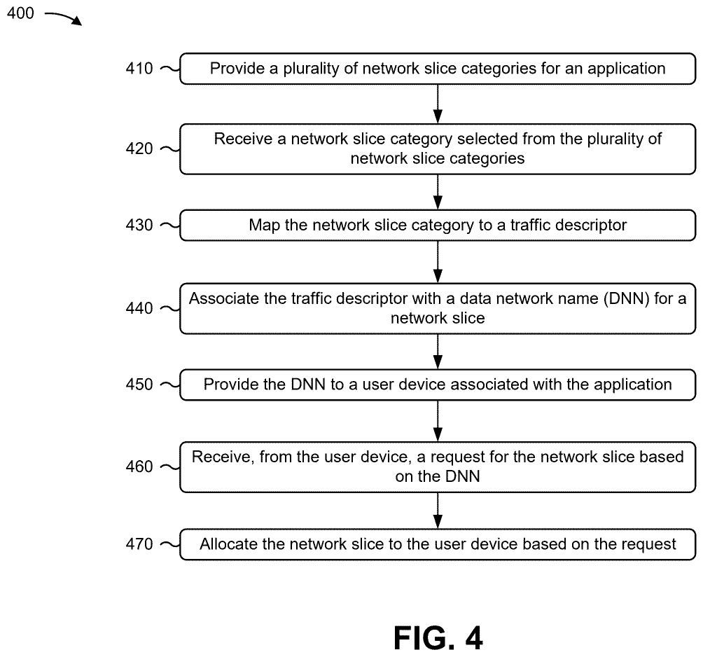

FIG. 4 depicts a flowchart of an example process 400 for automating network slice assignment. In some implementations, one or more process blocks of FIG. 4 may be performed by a device (e.g., the network system 110). In some implementations, one or more process blocks of FIG. 4 may be performed by another device or a group of devices separate from or including the device, such as a user device (e.g., the user device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include providing a plurality of network slice categories for an application (block 410). For example, the device may provide a plurality of network slice categories for an application, as described above. In some implementations, the application is an enterprise-managed application. In some implementations, the plurality of network slice categories includes one or more of a communication network slice category, a gaming network slice category, a streaming network slice category, an enterprise network slice category, a prioritized bandwidth network slice category, or a prioritized latency network slice category.

As further shown in FIG. 4, process 400 may include receiving a network slice category selected from the plurality of network slice categories (block 420). For example, the device may receive a network slice category selected from the plurality of network slice categories, as described above. In some implementations, receiving the network slice category selected from the plurality of network slice categories includes receiving the network slice category based on a selection from the plurality of network slice categories by the application developer via an application store. In some implementations, receiving the network slice category selected from the plurality of network slice categories includes one of receiving the network slice category based on the application developer selecting the network slice category from the plurality of network slice categories, or receiving the network slice category based on the device automatically selecting the network slice category from the plurality of network slice categories.

As further shown in FIG. 4, process 400 may include mapping the network slice category to a traffic descriptor (block 430). For example, the device may map the network slice category to a traffic descriptor, as described above.

As further shown in FIG. 4, process 400 may include associating the traffic descriptor with a DNN for a network slice (block 440). For example, the device may associate the traffic descriptor with a DNN for a network slice, as described above. In some implementations, associating the traffic descriptor with the DNN includes associating the traffic descriptor with a DNN that is pre-configured for the network slice.

As further shown in FIG. 4, process 400 may include providing the DNN to a user device associated with the application (block 450). For example, the device may provide the DNN to a user device associated with the application, as described above. In some implementations, providing the DNN to the user device includes providing the DNN to the user device via a URSP.

As further shown in FIG. 4, process 400 may include receiving a request for the network slice based on the DNN (block 460). For example, the device may receive a request for the network slice based on the DNN, as described above. In some implementations, receiving the request for the network slice based on the DNN includes receiving the request for the network slice based on the user device launching the application and based on the DNN.

As further shown in FIG. 4, process 400 may include allocating the network slice to the user device based on the request (block 470). For example, the device may allocate the network slice to the user device based on the request, as described above. In some implementations, allocating the network slice to the user device based on the request includes allocating the network slice to the user device based on the request and for provision of the application.

In some implementations, process 400 includes receiving a request for the application from the user device, and providing the DNN to the user device includes providing the application and the DNN to the user device based on receiving the request for the application. In some implementations, process 400 includes categorizing a plurality of applications into the plurality of network slice categories for an application store. In some implementations, process 400 includes enabling an enterprise user, associated with the user device, to select custom network slice for the application. In some implementations, process 400 includes storing the traffic descriptor and the DNN for future requests for the network slice.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
providing, by a device, a plurality of network slice categories for an application;
receiving, by the device, a network slice category selected from the plurality of network slice categories;
mapping, by the device, the network slice category to a traffic descriptor;
associating, by the device, the traffic descriptor with a data network name (DNN) for a network slice;
providing, by the device, the DNN to a user device associated with the application;
receiving, by the device and from the user device, a request for the network slice based on the DNN; and
allocating, by the device, the network slice to the user device based on the request.

2. The method of claim 1, further comprising:
receiving a request for the application from the user device,
wherein providing the DNN to the user device comprises:
providing the application and the DNN to the user device based on receiving the request for the application.

3. The method of claim 1, wherein receiving the request for the network slice based on the DNN comprises:
receiving the request for the network slice based on the user device launching the application and based on the DNN.

4. The method of claim 1, wherein allocating the network slice to the user device based on the request comprises:
allocating the network slice to the user device based on the request and for provision of the application.

5. The method of claim 1, further comprising:
categorizing a plurality of applications into the plurality of network slice categories for an application store.

6. The method of claim 1, wherein receiving the network slice category selected from the plurality of network slice categories comprises:
receiving the network slice category based on a selection from the plurality of network slice categories via an application store.

7. The method of claim 1, wherein the application is an enterprise-managed application.

8. A device, comprising:
one or more processors configured to:
provide a plurality of network slice categories for an application,
wherein the application is an application not managed by an enterprise;
receive a network slice category selected from the plurality of network slice categories;
map the network slice category to a traffic descriptor;
associate the traffic descriptor with a data network name (DNN) for a network slice;
provide the DNN to a user device associated with the application;
receive, from the user device, a request for the network slice based on the DNN; and
allocate the network slice to the user device based on the request.

9. The device of claim 8, wherein the one or more processors, to associate the traffic descriptor with the DNN, are configured to:
associate the traffic descriptor with a DNN that is pre-configured for the network slice.

10. The device of claim 8, wherein the one or more processors are further configured to:
enable an enterprise user, associated with the user device, to select a custom network slice for the application.

11. The device of claim 8, wherein the one or more processors, to provide the DNN to the user device, are configured to:
provide the DNN to the user device via a user equipment route selection policy.

12. The device of claim 8, wherein the plurality of network slice categories includes one or more of a communication network slice category, a gaming network slice category, a streaming network slice category, an enterprise network slice category, a prioritized bandwidth network slice category, or a prioritized latency network slice category.

13. The device of claim 8, wherein the one or more processors are further configured to:
store the traffic descriptor and the DNN for future requests for the network slice.

14. The device of claim 8, wherein the one or more processors, to receive the network slice category selected from the plurality of network slice categories, are configured to:
receive the network slice category based on a user selecting the network slice category from the plurality of network slice categories; or
receive the network slice category based on the device automatically selecting the network slice category from the plurality of network slice categories.

15. A non-transitory computer-readable medium storing a set of instructions, the set of instructions comprising:
one or more instructions that, when executed by one or more processors of a device, cause the device to:
provide a plurality of network slice categories for an application;
receive a network slice category selected from the plurality of network slice categories;
map the network slice category to a traffic descriptor;
associate the traffic descriptor with a data network name (DNN) for a network slice;
store the traffic descriptor and the DNN for future requests for the network slice;
provide the DNN to a user device associated with the application;
receive, from the user device, a request for the network slice based on the DNN; and
allocate the network slice to the user device based on the request.

16. The non-transitory computer-readable medium of claim 15, wherein the one or more instructions, that cause the device to receive the request for the network slice based on the DNN, cause the device to:
receive the request for the network slice based on the user device launching the application and based on the DNN.

17. The non-transitory computer-readable medium of claim 15, wherein the one or more instructions further cause the device to:
categorize a plurality of applications into the plurality of network slice categories for an application store.

18. The non-transitory computer-readable medium of claim 15, wherein the one or more instructions, that cause the device to receive the network slice category selected from the plurality of network slice categories, cause the device to:
receive the network slice category based on a selection from the plurality of network slice categories via an application store.

19. The non-transitory computer-readable medium of claim 15, wherein the one or more instructions, that cause the device to provide the DNN to the user device, cause the device to:
provide the DNN to the user device via a user equipment route selection policy.

20. The non-transitory computer-readable medium of claim 15, wherein the one or more instructions, that cause the device to receive the network slice category selected from the plurality of network slice categories, cause the device to:
receive the network slice category based on selecting the network slice category from the plurality of network slice categories; or
receive the network slice category based on the device automatically selecting the network slice category from the plurality of network slice categories.
